(19) United States
(12) Patent Application Publication
(10) Pub. No.: US 2026/0211137 A1
(43) Pub. Date: Jul. 23, 2026

(54) METHOD AND RELATED APPARATUSES FOR ANALYSING A TARGET REGION BENEATH A SURFACE OF THE EARTH

(71) Applicant: FNV IP B.V., Leidschendam (NL)

(72) Inventors: Myrna STARING, Leidschendam (NL); Rod EDDIES, Leidschendam (NL)

(73) Assignee: FNV IP B.V., Leidschendam (NL)

(21) Appl. No.: 19/140,011

(22) PCT Filed: Dec. 19, 2023
(86) PCT No.: PCT/EP2023/086528

§ 371 Date: Jun. 17, 2025

(30) Foreign Application Priority Data
Dec. 23, 2022 (NL) 2033831

(51) Int. Cl. G01V 1/28; G01V 1/30

(52) U.S. Cl. CPC G01V 1/282; G01V 1/303; G01V 2210/324; G01V 2210/675

(57) ABSTRACT

A method for determining one or more ground properties of a target region beneath a surface of the earth, the method comprising: receiving a data set, the data set comprising: a first response signal, the first response signal indicative of the ambient noise measured at or near the surface by a first receiver arranged at a first location; and a second response signal, the second response signal indicative of the ambient noise measured at or near the surface by a second receiver arranged at a second location, wherein the first and second locations are different; processing the first and second response signals; cross-correlating the processed first response signal with the processed second response signal; and performing tomographic inversion using the cross-correlated response signals to generate a two-dimensional ‘2D’ or three-dimensional ‘3D’ model of the target region in terms of the one or more ground properties. Unlocking insights from Geo-Data, the present invention further relates to improvements in sustainability and environmental developments: together we create a safe and liveable world.

### FIELD

The disclosure relates to methods and systems for analysing a target region beneath a surface of the earth. More particularly, the disclosure relates to a method and system for determining one or more ground properties of a subsurface target region based on ambient noise measured at or near the surface. Unlocking insights from Geo-Data, the present invention further relates to improvements in sustainability and environmental developments: together we create a safe and liveable world.

### BACKGROUND

There is a general and ongoing need for systems and methods for determining subsurface ground parameters. In particular, there is a need for systems and methods that can be used to model the properties of a target volume beneath the surface of the earth to provide the information useful for infrastructure planning, such as but not limited to foundation design, underground infrastructure and underground storage. Determination of subsurface ground properties during the early planning phase of construction projects reduces uncertainty during the location determination, foundation design, and construction phases of a project. This in turn reduces delays, overspend, and unnecessary use of material resources (e.g. concrete) during construction.

One key parameter for the determination of ground characteristics in a volume of interest is shear-modulus and shear-velocity Vs. The shear-velocity Vs is the velocity at which a shear wave moves through the material and is controlled by the shear-modulus of the material. The relationship between shear-velocity and shear-modulus G is defined by Vs=√G/p, where p is the density of the material. Measurement of Vs therefore provides a valuable insight to the ground properties of a subsurface ground region. Small-strain shear modulus (Gmax) is also important in foundation design, wherein Gmax=ρ·Vs².

Spectral analysis of surface waves (SASW) and multi-channel analysis of surface waves (MASW) are both examples of techniques for gathering surface wave information that can be used in the determination of ground properties in a subsurface volume. For completeness, surface waves are waves occurring at or near the earth's surface. In both SASW and MASW, surface-level vibrations are measured, either from a passive source (vibrations in the surface as a result of ambient sources of noise) or an active source (e.g. a weight drop), and the dispersion of the resulting surface waves is studied. ReMi (Refraction Microtremor) is another surface-level technique that uses ambient noise and surface waves to infer ground properties of a subsurface region based on the observation of ambient noise at the surface.

Down-hole and cross-hole techniques can also be used to determine ground properties of a subsurface region. In both of these methods, a receiver located in a bore hole measures waves received from an active source located elsewhere. In a down-hole technique, one of the source and the receiver is located at a subsurface location within the bore hole and the other of the source and the receiver is located at the surface. In a cross-hole technique, a source is located in a first bore hole, with a receiver located in a second bore hole. In both down-hole techniques, the propagation and dispersion of the received waves are studied to infer the properties of the material through which the waves from the receiver have travelled.

Invasive techniques for measuring ground properties of a subsurface region can often present logistical challenges such as long duration of the processes and thus low cost efficiency, e.g. long process set-up, long acquisition times and/or heavy machinery, equipment and processes. Invasive techniques are particularly undesirable, especially in urban or inaccessible environments, and are often prohibitively expensive. Invasive techniques may also be unfriendly to the environment, e.g. cause disturbance to the local fauna. Conversely, current surface-level techniques may lack the accuracy and reliability of more invasive analysis techniques.

### OVERVIEW

This overview introduces concepts that are described in more detail in the detailed description. It should not be used to identify essential features of the claimed subject matter, nor to limit the scope of the claimed subject matter.

According to a first aspect, there is provided a method for determining one or more ground properties of a target region beneath a surface of the earth, the method comprising: receiving a data set, the data set comprising: a first response signal, the first response signal indicative of the ambient noise measured at or near the surface by a first receiver arranged at a first location; and a second response signal, the second response signal indicative of the ambient noise measured at or near the surface by a second receiver arranged at a second location, wherein the first and second locations are different; processing the first and second response signals; cross-correlating the processed first response signal with the processed second response signal; and performing tomographic inversion using the cross-correlated response signals to generate a two-dimensional ‘2D’ or three-dimensional ‘3D’ model of the target region in terms of the one or more ground properties.

Advantageously, a non-invasive technique for measuring ground properties of a subsurface target region—such as a possible site for a new underground construction—is thus provided. The advantages of being able to generate a 2D or 3D model of the ground properties of such a target region in a non-invasive way and using only ambient noise are numerous. It is simpler, faster, cheaper, less energy intensive, and less impactful on local environment, wildlife and communities than existing intrusive methods for site analysis. This is because less or no drilling and less active noise stimulation is required. Additionally, and crucially, the disclosed method is both accurate and reliable, making it a practical and technically attractive technique. The disclosed approach is especially well suited to use in urban environments due to its low impact characteristics and because urban environments provide a plentiful supply of ambient noise in a frequency range well suited to the disclosed method.

The disclosed method is particular advantageous for providing targeted follow-on investigations. While some intrusive measurements may still be needed for calibration and ground-truth purposes, the method according to the present invention allows for detecting ground anomalies as well as targeting areas where ground anomalies are predicted instead of randomly determining ground properties by drilling across the site. This significantly reduces the number of intrusive investigations needed. The list of benefits according to the present invention thus include a faster delivery of the desired insights or properties of the ground and so: reduces the time required; reduces capital expenditure compared to conventional ground investigations; allows the use of less heavy machinery and equipment through lighter and more sustainable engineering, and thereby improves safety of operations and minimizes environmental exposure risks too. In conclusion therefore, globally, the method according to the present invention allows for better risk management and/or risk transfer than conventional ground investigation methods.

The target region may span from 0 to 100 m below the surface; 0 to 45 m below the surface; or 50 to 100 m below the surface. Further depths may also become target regions as the method according to the present invention presents little technical limits. Advantageously, the described approach is thus suitable for analysing a range of target region depths and profiles. This makes it very versatile.

The target region may be a possible site for a new construction, or a tunnel. Ground risk management framework decisions may be taken based on the 2D or 3D model. At an early stage of the construction project, the method according to the present invention provides very important information and insights into the ground properties and thus provides the best opportunity to influence the outcome of a project at minimum cost of change. For example, plans for building in or near the target region may be adapted based on the 2D or 3D model. The method may be carried out as part of a feasibility study—for example, early site screening—for building in or near the target region. By placing more emphasis on early site screening, uncertainty in building projects is reduced. This translates to significant material, time, and cost savings. For example, reduced uncertainty leads to better risk management, which in turn leads to the avoidance of excessive over engineering in projects. This can help reduce material usage, such as concrete and steel usage, which has significant environmental benefits. Furthermore, early site screening helps inform further analysis of the target region so that any further analysis, which may be intrusive in character, can focus only on those regions allegedly identified as problematic or only on certain regions of particular interest.

Ambient noise, or seismic ambient noise, may be generated by one or more sources. The sources may be natural (that is, naturally occurring vibrations) or cultural (that is, vibrations from human activity). For example, the sources may include ocean(s) (for example, tidal or wave noise), wind, industry, industrial machinery, vehicles such as cars or trains, and human noise (for example, footsteps). Analysing one or more ground properties of the target region based on already occurring ambient noise is a practical, convenient, energy efficient and low cost approach.

The receivers used in the present methods may be geophones, accelerometers, seismometers, vibration sensors and/or transducers. The receivers may collect data over a significant period of time. For example, the ambient noise may be measured consecutively over a period of five days. This longer recording time results in the adequate retrieval of surface wave information from the ambient noise recorded at or near the surface of the target region. In turn, and as described in more detail below, the (processed) surface wave information can be used in a tomographic inversion to obtain a shear wave velocity model of the subsurface.

Each response signal may be indicative of the Rayleigh waves and/or Love waves caused by the ambient noise.

Each of the first and second response signals may be indicative of the vertical and/or horizontal component of the ambient noise measured at or near the surface by the first and second receiver, respectively.

The method may comprise, before the step of receiving the data set, determining the locations for the first and second receivers. The locations may be locations on or near the surface. The locations may be based on the minimum and/or maximum depth of the target region and/or the desired resolution of the waves in the target region caused by the ambient noise. By determining the locations for the receivers based on the minimum and/or maximum depth of the target region and/or the desired resolution of the noise waves in the target region, the first and second receivers are best placed to measure the noise waves at their most sensitive. This contributes to the accuracy of the response signals and thus the resulting 2D or 3D model.

There may be more than two receivers. The receivers may be arranged in an array (line or grid).

The method may comprise, before the step of receiving the data set, selecting a recording frequency for the first and second receivers. The recording frequency may be selected based on the depth of the target region and/or the expected wavelength of the noise waves in the target region. The recording frequency may be called a target recording frequency and may be a range.

The one or more ground properties may comprise one or more elastic properties of the target region, such as the shear-velocity, Vs. As explained above, retrieving the shear-velocity of the target region provides a valuable insight to the ground properties of the target region, such as the small-strain shear modulus of the target region. This allows engineers to identify areas of weakness in the subsurface target region, say, or lateral variations in the geology. For the reasons provided above, the earlier on in the project lifecycle that such characteristics can be identified, the better.

The step of processing may comprise processing the first and second response signals to accentuate the representation of the ambient noise. Put another way, to accentuate the broad band characteristics of the ambient noise. For example, by removing the instrument response and/or by filtering out large amplitudes. Such large amplitudes may be caused by (undesired) signals from earthquakes. Advantageously, this prevents large amplitude events from overpowering the ambient noise response that is of interest.

Additionally or alternatively, the step of processing may comprise one or more of: splitting each response signal into segments; trimming each (optionally, segmented) response signal to the nearest second; applying a low-pass filter to each response signal; and/or downsampling each response signal. The method may comprise downsampling each response signal by a factor that is an integer number. For example, the method may comprise downsampling the at least two response signals by a factor of around 10 (for example, by a factor of 10). The advantage of segmenting and trimming the data is that this allows response signals measured by different receivers to be cross-correlated and stacked to obtain an estimate of the Green's function between the two receivers. The advantage of applying a low-pass filter is that this reduces the frequency content of each response signal to only those frequencies which can be retrieved unaliased after the subsequent cross-correlation step. Aliasing occurs when the signal is not sampled properly enough to reconstruct the waveform for certain frequencies The advantage of downsampling is that this reduces the computational cost of the method and the total time required to generate the model.

The step of cross-correlating the processed response signals may comprise estimating the Green's function between the first and second receivers. In other words, the step of cross-correlating the at least two processed response signals may comprise simulating the wavefield that would be recorded at one of the first and second receivers if the other of the first and second receivers were a virtual source. For completeness, the step of cross-correlating may be applied to the segmented and/or downsampled and/or trimmed response signals. Advantageously, by cross-correlating the response signals, the similarities between the response signals are analysed. This is an important step towards generating the model.

The step of performing tomographic inversion may comprise using only fundamental mode surface waves in the inversion. Advantageously, using only the fundamental mode surface waves results in a good level of accuracy for the model.

The inversion may be performed in the time domain or the frequency domain. Usefully, having the choice between the time domain or the frequency domain means that the domain resulting in the shorter processing time can be selected.

The step of performing tomographic inversion may comprise using a combination of tomography and inversion.

The step of performing tomographic inversion may follow a one-step approach or a two-step approach.

The step of performing tomographic inversion may comprise providing an initial model of the one or more ground properties of the target region; providing a noise input for the initial model; calculating, using the initial model, the travel time of the response signal that would be measured at the first and second receivers; comparing the travel time calculated using the initial model to the cross-correlated first and second response signals; and based on the comparison, updating the initial model to generate the 2D or 3D model.

The step of providing the initial model may comprise determining the phase velocity dispersion profile between a virtual source and one of the first and second receivers.

The step of providing the initial model may comprise determining the (for example, 2D or 3D) structure of the initial model by computed tomography of two or more phase velocity dispersion profiles selected between different virtual sources and different receivers.

The 2D model may be a 2D expression of the shear-velocity of the target region. The 3D model may be a 3D expression of the shear-velocity of the target region.

The method may be a computer-implemented method.

The method may be used in combination with one or more further techniques for analysing surface waves, such as SASW or MASW. Usefully this allows for analysing the subsurface over a larger depth range.

According to another aspect, there is provided a computer program product comprising instructions which, when the program is executed by a computer, cause the computer to carry out the method of the first aspect.

According to a further aspect, there is provided apparatus configured to perform the method of the first aspect.

The apparatus may be a system comprising: one or more processors; one or more memories having stored thereon computer readable instructions configured to cause the one or more processors to perform operations comprising the steps of the first aspect.

According to still another aspect, there is provided computer-readable medium comprising instructions which, when executed by a computer, cause the computer to carry out the method of the first aspect.

### BRIEF DESCRIPTION OF THE DRAWINGS

Illustrative implementations of the present disclosure will now be described, by way of example only, with reference to the drawings. In the drawings:

FIG. 1 shows a cross-sectional view of a subsurface target region;

FIG. 2 shows a plurality of geophones arranged in a 2D array at a surface above a subsurface target region;

FIG. 3 is a flow chart showing an example method for analysing one or more ground properties of a target region;

FIG. 4 is a flow chart showing an example method for performing tomographic inversion that can be used in the method of FIG. 3;

FIG. 5 is a perspective view of a shear wave velocity model;

FIG. 6 is an example of a shear wave velocity model resulting from the methods described herein; and

FIG. 7 shows a block diagram of one implementation of a computing device 700 which can be used to perform the methods of FIG. 3 and FIG. 4.

Throughout the description and drawings, like reference numerals refer to like features.

### DETAILED DESCRIPTION OF THE DRAWINGS

A method for analysing one or more ground properties, such as the shear velocity, of a subsurface target region will now be described. In short, the method involves receiving a data set indicative of the ambient noise at the surface of the subsurface region, as measured at or near the surface by receivers; performing various operations on the data; and, ultimately, generating a 2D or 3D model of the target region in terms of the one or more ground properties. As has already been described, the ability to generate a 2D or 3D model of a target region—such as a candidate site for a new construction—in terms of its shear velocity, for example, provides a valuable insight into the composition of the target region. In turn, this can be used to influence subsequent site surveys and construction decisions.

Ambient noise is generated from various sources. The sources fall under two categories: natural and cultural. Natural sources are those such as oceans or the wind which cause naturally occurring vibrations. Cultural sources are those which stem from human activity, such as industry, industrial machinery, vehicles such as cars or trains, power lines, and human noise.

More specifically, the received data set includes response signals. Each response signal is measured at or near the surface by a respective receiver. The response signals are indicative of the amplitude of the ambient noise that was transmitted from various noise sources (these could be cultural and/or natural sources, as explained more below) through the subsurface and measured by the respective receiver. In particular, the vibrations resulting from surface waves are measured. Surface waves are generated by cultural or natural processes occurring at or near the surface. The elliptical motion and dispersive properties of the surface waves allow us to retrieve information about the ground, for example shear, properties of the subsurface region.

The receivers, which may also be considered to be sensors, may be geophones, accelerometers, seismometers, vibration sensors and/or transducers.

Information useful for understanding the present invention will now be provided.

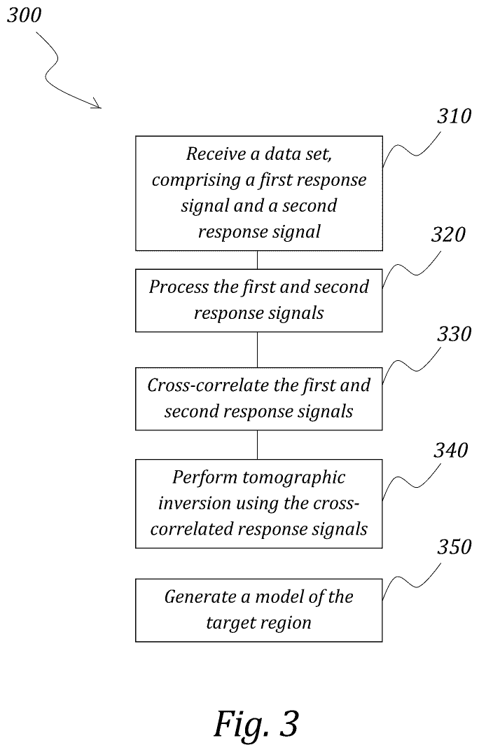

First, an explanation of shear modulus and its usefulness in building and infrastructure projects will be given. Shear modulus is a measure of the elastic shear stiffness of a material and represents the deformation of a solid when it experiences a force parallel to one of its surfaces while its opposite face experiences an opposing force. Such forces and their effects in subsurface ground volumes (such as the target region of the method described in connection with FIG. 3), are an important parameter for study before and during the design of building and infrastructure projects. To determine the shear modulus of a volume, the shear velocity, Vs, is determined. This in turn gives an indication of the stiffness of the subsurface material, and its ability to support structures extending above and/or through the volume.

Next, an explanation of wave types will be given. In the context of ground study, two types of waves are generally distinguished: P-waves and S-waves. In P-waves, particles in the volume oscillate in the direction of movement of the wave, which causes a compression and de-compression of the ground as the waves propagate through the ground. Meanwhile S-waves are shear waves, in which particles oscillate in a direction perpendicular to the direction of propagation of the waves.

P-waves and S-waves are body waves and propagate in all directions through the body of the volume. The interaction of P- and S-waves with the earth's surface generates surface waves, which propagate along that surface. Several types of surface waves can be distinguished. In the systems and methods described herein, Rayleigh waves are measured and studied because it is convenient to measure the vertical component of surface vibrations. However, it will be appreciated that other surface waves (e.g. Love waves) may be measured and harnessed in the systems and methods described herein. The systems and methods described herein can be adapted to measure Rayleigh waves and/or Love waves by using single component receivers or multi-component receivers.

Because surface waves propagate in 2D (at the surface), they attenuate less rapidly than body waves (which propagate in 3D). Surface waves are generally present within a depth range of one wavelength from the surface, generally travel more slowly and have a predominantly lower frequency than body waves.

This lower attenuation, slower travel time and lower frequency of surface waves makes their study particularly attractive for the purposes of determining shear velocity, Vs. Since the surface waves have lower attenuation, the signal strength is better maintained over a longer travel distance. The resulting measurement results therefore generally have a higher signal quality (signal-to-noise ratio) than body wave studies.

Some of the subsequent examples will be described in the context of geophones and a geophone array. It will, however, be appreciated that the disclosed systems and methods are applicable to a variety of receiver (that is, sensor) types, including but not limited to geophones, accelerometers, seismometers, vibration sensors and/or transducers.

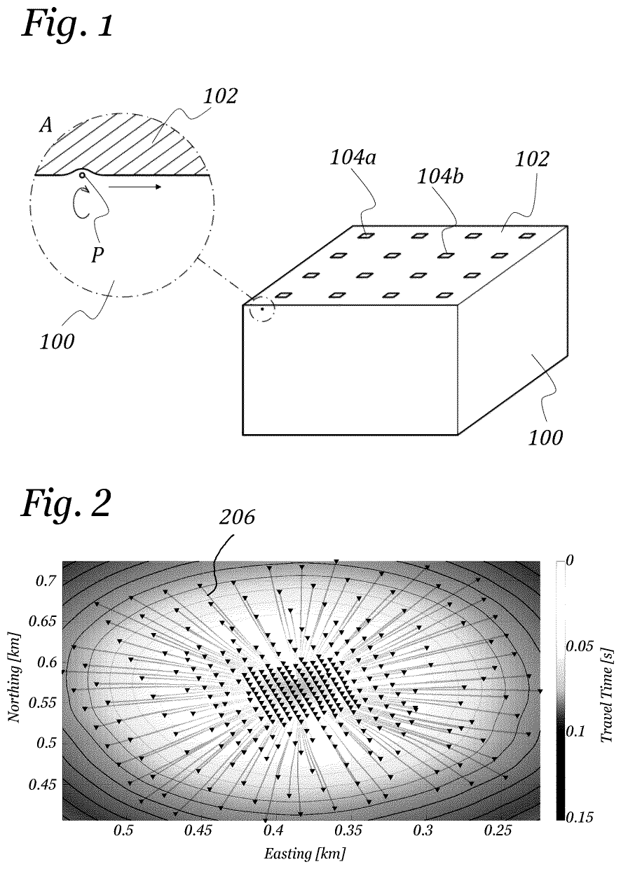

An example physical setup for collecting data indicative of the ambient noise at the surface of a target region will now be described in reference to FIG. 1. FIG. 1 shows a cross-sectional view of a subsurface volume 100, such as the target region of the method described in connection with FIG. 3. P- and S-waves travel through the volume 100 as body waves. A surface 102 extends above the subsurface volume. Surface waves propagate along the surface 102.

At point A, a schematic representation of a particle oscillation (due to Rayleigh wave propagation) at a surface above a target subsurface volume is shown. As illustrated, the oscillation of the particle P is partly vertical and partly in the direction of propagation. The resulting particle movement is therefore substantially ellipsoid.

At a surface 102 above the volume 100, a plurality of geophones 104a, 104b are arranged. Geophones 104aa, 104b, located at surface 102 can be configured to measure the vertical component of the oscillation shown schematically at point A.

The geophones 104a, 104b, are arranged in a grid array at the surface, the grid extending in two directions. It should be noted that the surface above the target region may, in many cases, not be planar. The array of geophones 104a, 104b, may therefore not be truly “two-dimensional” because each geophone may be offset from its neighbours in the grid in the z-direction. However, such a grid arrangement of geophones will be referred to as a 2D array herein.

A surface wave travelling across surface 102 will cause vertical movement at a plurality of geophones 104a, 104b, as waves travel across the surface.

It will now be described, in general terms, how the shear velocity, Vs, can be determined from the observation of surface waves (in particular Rayleigh waves). This is achieved by measuring the dispersive behaviour of the surface waves. Surface waves are dispersive, which means that their velocity is dependent on frequency. Usually, seismic velocities increase with depth in the earth. As a consequence, normal surface wave dispersion shows a decrease of surface-wave velocity with increasing frequency. It is by studying the behaviour of surface waves at a surface above a volume that the ground properties of the volume can be determined.

There are two ways to measure the velocity in dispersive surface waves and a distinction is made between the determination of group velocity or phase velocity.

The group velocity of a wave is the velocity with which the overall envelope shape of the wave's amplitudes—known as the modulation or envelope of the wave—propagates through space. The group velocity is equivalent to the speed with which the energy of the wave propagates through the volume. The group velocity is measured by determining the wave propagation between a (synthetic) transducer pair and is a frequency-dependent point property in the volume, which is dependent on depth. The group velocity is obtained as a time of flight (that is, travel time) measurement between a virtual source and a receiver.

Meanwhile, the phase velocity is the velocity at which the phase of any one frequency component of the wave travels. The phase velocity is the speed with which each frequency component of a wave travels. As such, the phase velocity is expressed as a function of frequency. To measure the phase velocity, at least two measurement nodes are chosen to measure the waves propagating through the volume to determine relative time of flight between the geophones for different frequencies. The result is the phase velocity as a function of frequency as averaged over the volume between the two measurement nodes. Phase velocity is acquired as a point in 2D phase space (dispersion spectrum) which is obtained by a 2D transform (such as slant-stack, Radon, FK, or the like) of an array of recorded waveforms (time-distance space).

Referring again to FIG. 1, each geophone 104a, 104b, provides a measurement node for measuring the vertical component of passing surface waves. The geophones 104a, 104b, can be configured to measure vibrations due to ambient noise. For completeness, as previously described, ambient noise is the background wavefield due to natural or man-made/human noise (rather than an impulse point such as an explosion or hammer drop used in active methods).

By cross-correlating the passive noise signals measured at a pair of receivers, the Green's function for the pair can be obtained, which represents the wavefield as if one of the pair were a virtual(e.g. noise) source and the other of the pair were a receiver.

FIG. 2 shows a plurality of virtual source-receiver pairs across a surface above a subsurface region of interest. Ray paths 206 between source-receiver pairs are indicated. In particular, the ray paths from a single central geophone near the centre of the array and each other geophone in the array. The background shading and contour rings indicate the travel-time field from the central geophone to the other geophones. In practice, there are also corresponding ray paths between each geophone and all other geophone (that is, between every pair of geophones), which are not depicted in FIG. 2 for simplicity.

Each pair of geophones can provide a signal at location A to be cross-correlated with a signal at location B to reproduce a virtual source-receiver pair using the principle of interferometry. In particular, the cross-correlation of passive noise measured at respective pairs of geophones at the surface shown in FIG. 1 can be used to reproduce a response from the sub-surface target volume, as if it were induced by an impulse point source, which is equal to Green's function.

In other words, a response that is received by cross-correlating two receiver recordings can be interpreted as a response that would have been measured at one of the receiver locations as if there were a source at the other. Various approaches to determining the Green's function for a virtual source-receiver pair are known, with an overview of the approaches described in “Tutorial on Seismic Interferometry: Part 1—Basic Principles and Applications”; GEOPHYSICS. Vol. 75, No 5 (Sept-Oct 2010; P.75A195075A209; Wapenaar et al.).

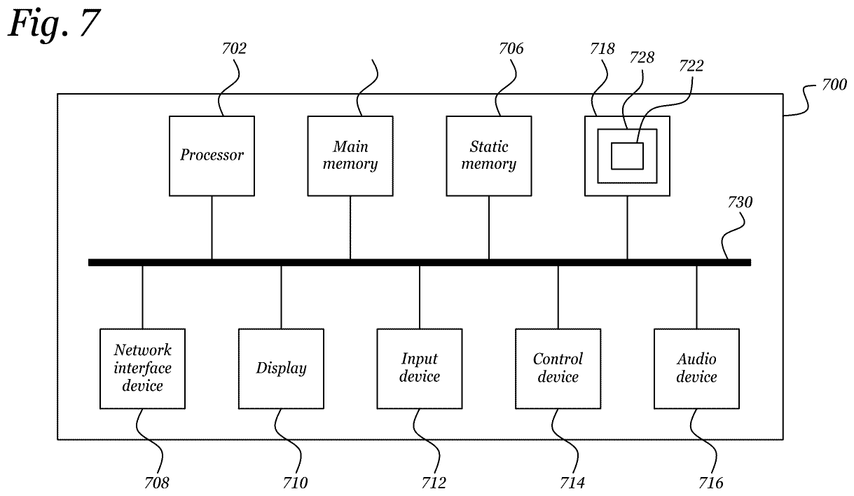

An exemplary method 300 for determining one or more ground properties of a target region beneath a surface of the earth, such as volume 100, is shown in FIG. 3. The method 300 may be a computer-implemented method. Computer apparatus 700 which can be used to perform the method is described later in reference to FIG. 7.

The method 300 begins at step 310. At step 310, a data set is received. The data set comprises a first response signal. The first response signal is indicative of the ambient noise measured at or near the surface 102 by a first receiver arranged at a first location. The data set also comprises a second response signal. The second response signal is indicative of the ambient noise measured at or near the surface by a second receiver arranged at a second location. The first and second locations are different. The first and second receivers measure the vibrations in the surface and output a voltage response.

The response signal collected in each measurement may be indicative of the amplitude of the ambient noise that was transmitted from various cultural or natural ambient noise sources through the subsurface and measured by the first and second receivers (such as vibration sensors/transducers). Particularly, the vibrations resulting from surface waves are measured. As has been discussed, surface waves are generated by cultural or natural processes occurring at or near the surface. Their elliptical motion and dispersive properties allow us to retrieve information on the shear properties in the target region. In this example, the first and second response signals are each indicative of the vertical component of the ambient noise measured at or near the surface by the first and second receiver, respectfully. In other examples, the first and second response signals are each indicative of the horizontal, and optionally additionally vertical, component of the ambient noise measured at or near the surface by the first and second receiver, respectively.

The first and second signals may be received directly from the first and second receivers, or via one or more intermediary devices. For example, a computing device (as described below with reference to FIG. 7), may be situated locally to the receivers for the signals to be transmitted via any form of wired or wireless communication. Alternatively, the signals may be received at a location far away (that is, remote) from the location of the receivers for performing the methods disclosed herein remotely, for example by internet communication or transporting a physical computer-readable medium with a recording of the signals saved thereon. In some examples, the first and second signals are received in real time. In other examples, the first and second signals are received after recording has finished, or at intervals throughout recording sessions.

Optionally, the method 300 may comprise, before step 310 of receiving the data set, selecting a recording frequency for the first and second receivers. The recording frequency may be selected based on the depth of the target region and/or the expected wavelength of the noise waves in the target region. Additionally or alternatively, the recording frequency for a given receiver may be selected based on its characteristics, such as its optimum recording frequency or frequency range The recording frequency may be called a target recording frequency and may be a range. Advantageously, this means that the recording frequency can be optimised for the characteristics of the target region and the ambient noise in the target region, which means that the use of an excessively high recording can be avoided. This helps reduce the processing burden involved with having excessive data points.

Optionally the method 300 may comprise before step 310 of receiving the data set, determining the locations for the first and second receivers. The locations may be locations on or near the surface. The locations may be based on the minimum and/or maximum depth of the target region and/or the desired resolution of the waves in the target region caused by the ambient noise. By determining the locations for the receivers based on the minimum and/or maximum depth of the target region and/or the desired resolution of the noise waves in the target region, the first and second receivers are best placed to measure the noise waves at their most sensitive. This contributes to the accuracy of the response signals and thus the resulting 2D or 3D model.

Next, at step 320, the first and second response signals are processed. The first and second response signals are processed to optimise them for the subsequent steps of the method. Processing of the first and second response signals is described later in this description.

Next, at step 330, the first and second response signals are cross-correlated. The purpose of the cross-correlation is to simulate the wavefield that would be recorded at one of the first and second receivers if the other of the first and second receivers were a virtual noise source, such that the cross-correlated response signals can be more easily compared. The simulated wavefield is an essential input to the next step of the method. The step of cross-correlation is described in more detail later in this description.

Next, at step 340, a tomographic inversion is performed using the cross-correlated response signals. Tomographic inversion is a combination of tomography and inversion. Tomography is the name given to techniques for displaying representations of object cross-sections using penetrating waves. In other words, tomography is the name given to imaging techniques which are based on penetrating waves. In this method, tomography is combined with inversion—either in one-step, or in two-steps. In this context, inversion is the name given to the process of taking the cross-correlated response signals and transforming them into a predicted 2D or 3D model of the target region in terms of the one or more ground properties (thus, in this example, in terms of shear velocity, Vs). Again, the step of tomographic inversion is described in more detail later in this application.

Finally, at step 350, the mentioned model of the target region in terms of its shear velocity is generated. This is the output from the tomographic inversion, and indeed the output from the method overall. It is this model which provides a valuable insight into the constitution of the target region and thus its suitability as a site for possible construction.

In some examples, the model is sent to an output device. For example, the model may be displayed on a monitor or other user interface, or sent via wired or wireless communication to another computing device for further processing or display.

The steps of the method 300 will now be described in more detail.

At step 320, the first and second response signals are processed. The overall aim of the processing is to optimise the first and second response signals for subsequent steps of the method 300, most particularly cross-correlation step 330. This involves obtaining broad band signals. In this example, each of the response signals is processed individually and a number of distinct operations may be carried out (on each response signals). These operations will now be described.

A first operation is to remove the instrument response from the response signals. This operation is sometimes referred to as designature or deconvolution and may be carried out in various ways, as will occur to the skilled person.

A second operation is to remove linear trend and mean from the response signals. This is called detrending and involves removing aspects from the response signals causing distortion (for example, overall linear increase in the mean) over time to reveal subtrends. It is these subtrends which typically are better representations of the ambient noise (and thus shear velocity) at the surface.

A third operation is to reduce spectral leakage. In the context of this disclosure and example, spectral leakage refers to an effect that occurs when the waves caused by ambient noise do not have a frequency which is periodic with the sampling interval of the receiver measuring them. The effect is that, in the measured signals, the frequency distribution is not entirely accurate: a particular frequency in the original wave may leak into (that is, fall within) two adjacent frequencies in the measured data, say, and thus give an inaccurate representation of the frequency profile of the wave (and so its amplitude). To reduce this undesirable effect, the edges of a seismogram plot of the noise measured at a particular receiver as a function of time are tapered with a cosine taper. In this example, the cosine taper is 5% of the trace length. Also in this example, the cosine taper is applied before a low-pass filter is applied (the latter will now be described). In other examples, the taper value may be different.

A fourth operation is to filter out anonymously large amplitude values, such as values having an amplitude above a threshold amplitude value. The filtering is carried out such that noise originating from transient events, such as earthquakes or instruments, which typically result in shear velocity waves in the surface having larger amplitude values than the waves caused by ambient noise, are filtered out. If these large amplitude events are not filtered out, they can overpower the ambient noise response.

In more detail, in certain examples, each response signal is plotted on a graph (over time) and any clear outliers—that is, data points with clearly outlying amplitude values—are identified. This can be done in an automated fashion or by visual inspection (by a human, say). If there is a clear outlier (or outliers), further investigation is done. The further investigation can include deducing whether the outlier pertains to a certain frequency band, deducing whether it is instrument noise, or deducing whether it is a transient signal (that we would like to remove). If a clearly anomalous amplitude is found to be present that is related to an event that overpowers the amplitude of the ambient noise, then the next step is to experiment with filter values and techniques known to the person skilled in the art for removing the anomalous data point. This is done in such a way as to leave the rest of the signal as untouched as possible.

A fifth operation is to split each response signal into shorter segments. The response signals received at step 310 of the method 300 may be indicative of the ambient noise measured at or near the surface over a period of several days. In this example, the response signals represent five days of measurements. It is beneficial to split up these potentially large data packets into shorter time segments to: allow for the response signals to be synchronized (that is, for time alignment); reduce computational burden (and thus speed up the processing); and allow for the signals to be more easily manipulated to focus on good patches (where the recording went well) in the subsequent analysis, and avoid bad data patches (where the recording did not go so well, for example due to receivers being disrupted by wildlife, say). A consistent approach to segmentation is taken across the response signals. In this example, the response signals are split into 24-hour periods. In other examples, the durations of the segments may be shorter, longer, or indeed each response signal may be segmented into segments of different durations.

Optionally, step 320 may also include ‘chunking’ the segmented response signals together. This means putting together multiple segmented response signals to greater longer signal chunks. These longer signal chunks may then be used in the cross-correlation of step 330 of the method 300. For completeness, after the cross-correlation, the cross-correlated longer signal chunks may be stacked up to represent even long periods of time. In some examples, multiple segmented response signals are chunked together to represent one hour windows of time. Such chunking processes are sometimes known as concatenation. Chunking is useful for optimization, including making best use of computer resources.

A sixth operation is to trim each response signal to the nearest second. This allows the response signals collected at different receivers to be synchronized (that is, for time alignment), as necessary later in the method 300. In this example, the segmented response signals are trimmed to the nearest whole second. In other examples, the raw or amplitude filtered response signals may by trimmed (with the segmentation optionally happening after). And different trim values may be used: the response signals may be trimmed to the nearest whole minute, for example, or the nearest millisecond.

A seventh operation is to apply a low-pass filter to each response signal (or indeed the segments of each response signal). This is to reduce high frequency components in the signals, which can cause aliasing. For completeness, aliasing is an undesirable effect which occurs when the sampling frequency is not high enough to accurately sample high frequency components of a signal. In short, aliasing results in inaccuracies in the data. The effect is minimised however by applying a low-pass filter and removing the high frequency components. In this example, the cut-off value (that is, corner frequency) is set to be one quarter of the desired sampling frequency. In this example, a desired sampling frequency is 1 Hz, and so an example cut-off value is 0.25 Hz.

An eighth operation may be to downsample the response signals. This reduces the amount of data that is processed in subsequent steps of the method 300 and thus reduces memory usage, computational burden, and—crucially—reduces the time taken to perform the method 300. This time saving makes the method 300 a practical choice for site analysis in even the most time pressured construction projects. In more detail, the response signals are downsampled by an integer number, n, such that only every nth sample is kept. In this example, n is 100. In other examples, the value of n may be different. The value of n chosen and used depends upon the highest non-aliased frequencies that it is possible to retrieve in that particular setting.

Optionally, the downsampling may be done in integer steps, such as by a factor of 4 or 5. For example, if n is 100, the data may be downsampled from 100 Hz to 20Hz, from 20Hz to 5 Hz, and finally to 1 Hz. This approach can be useful in examples where n is quite high, say, because the data may need a significant amount of downsampling.

In some examples, the order of the described operations is different to the order presented above. Additionally or alternatively, in some examples, the number of operations carried out is different. For example, a sub selection of the described operations may be carried out, as best suits the particular project being undertaken. Such sub selection is useful for adapting the analysis to the project requirements, which might include one or more of timings, cost, granularity of the final model required, and size of the target region.

At step 330, the processed response signals—here, the first and second processed response signals—are cross-correlated. In this section, the processed response signals may simply be referred to as response signals. The purpose of the cross-correlation is to simulate the wavefield that would be recorded at the receiver of one of the response signals if the receiver of the other were a virtual source. In other words, the wavefield between the first and second receivers is simulated for the case where one of the first and second receivers is a virtual source. Put another way, the recorded response signal in time at one of the first and second receivers is measured relative to the recorded response signal at the other of the first and second receivers. This gives the surface wavefield that has travelled in-between the receivers. Advantageously, by cross-correlating the response signals, the travel-time differences in the noise wavefield between the first and second receivers are retrieved. Step 330 is an important step towards generating the model at step 340 of the method 300.

In this example, the response signals have been segmented and trimmed, and so the first step in the cross-correlation is to select trimmed segments from the two (processed) response signals which correspond to the same time period. The particular segments (and thus time period) chosen is based on a variety of factors, such as the quality of the data in that time period. In other examples, the response signals may not have been trimmed and/or indeed processed at all.

The next step is to cross-correlate the response signals (or segments) and thereby obtain the Green's function which represents the wavefield between the two receivers, as if one of the receivers were a virtual source.

In this example, the at least two response signals are cross-correlated in the frequency domain; however cross-correlations can also be performed in the time domain. Conveniently, the user is able to choose the domain with the shorter expected processing time. This helps to reduce the overall time needed for the method 300.

The result from step 330 may be normalized before proceeding to step 340.

In other examples, where there are more than two receivers and thus more than two response signals in the data set input to the method 300, each response signal (or processed response signal) is cross-correlated with each other response signal and the Green's function is obtained from each cross-correlation result. In other words, each receiver is paired with each other receiver, and one Green's function (and thus wavefield simulation) is obtained per receiver pair, or per virtual source-receiver pair. The output from the cross-correlation between the response signal measured at a particular receiver selected as the virtual source and the response signals measured at each other of the plurality of receivers is a virtual source gather showing the Green's function between the virtual source and each other of the plurality of receivers, thereby creating a virtual shot gather. As previously discussed, an example wavefield simulation for a plurality of receivers from a single central geophone (a type of receiver) is shown in FIG. 2.

Overall the result of step 330 is a representation of the surface waves for the target region that can subsequently be used as the indirect measurement input for the production of the final model of ground properties of interest (which is obtained by solving the inverse problem of known response signals from a ground region having unknown properties). One approach to solving the inverse problem is a tomographic inversion, as will now be described.

At step 340, the cross-correlated response signals—here, the result of the cross-correlation of the first and second processed response signals—are/is used in a tomographic inversion. The result of the tomographic inversion at step 350 is the model of the target region.

To account for the fact that it is unlikely that the sources of ambient noise measured at the surface of the target region are homogenously distributed, in this example, only the fundamental mode (that is, first harmonic) surface waves are included in the tomographic inversion. This is because these surface waves are assumed to be reconstructed well for the cross-correlated receiver pair, despite the lack of homogeneity of the ambient noise.

A preparatory step in the exemplary tomographic inversion operation described herein is to determine the average phase velocity between the virtual source-receiver pair. The average group velocity is then calculated from the average phase velocity.

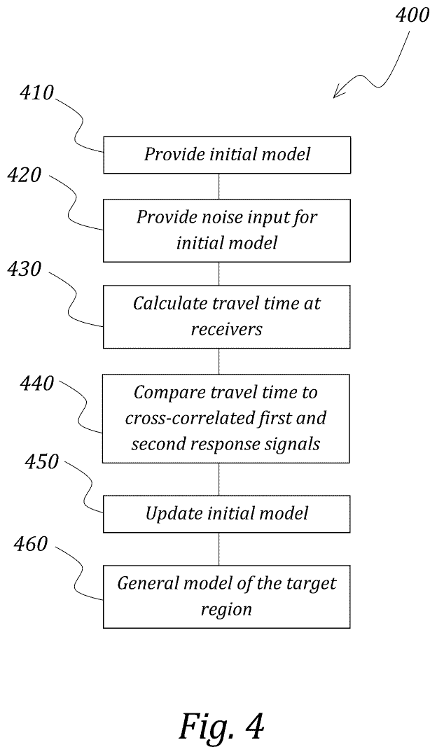

Exemplary tomographic inversion operations will now be described, first in reference to FIG. 4. FIG. 4 shows a method 400 for performing tomographic inversion that can be used at step 340 in the method 300. There are two distinct ways in which the method 400 can be carried out: as a one-step approach, or as two-step approach. The steps of the method 400 common to both approaches will now be described.

At step 410, an initial model of the one or more ground properties of the target region is provided. Advantageously, by using an initial model, the model generated in the method 300 may be arrived at more quickly.

At step 420, a noise input is provided to the initial model. The noise input is a theoretical noise input.

At step 430, the travel time of the response sign that would be measured at the first and second receivers as a result of the noise input is calculated.

At step 440, the travel time calculated at step 430 and the cross-correlated first and second response signals (that is, the output from step 330) are compared.

At step 450, the initial model is updated based on the result of the comparison.

At step 460, based on the updating of the initial model, the 2D or 3D model of the target region in terms of the one or more ground properties is generated.

The inversion may be performed in the time domain or the frequency domain. Usefully, this means the user can pick the approach resulting in the shorter processing time.

The one-step approach and the two-step approach for performing the method 400 will now be described.

Important to both the one-step and the two-step approach is an understanding of: (1) the grid of cells making up the model of the target region, and (2) of ray paths. A description of (1) and (2) will therefore now be given.

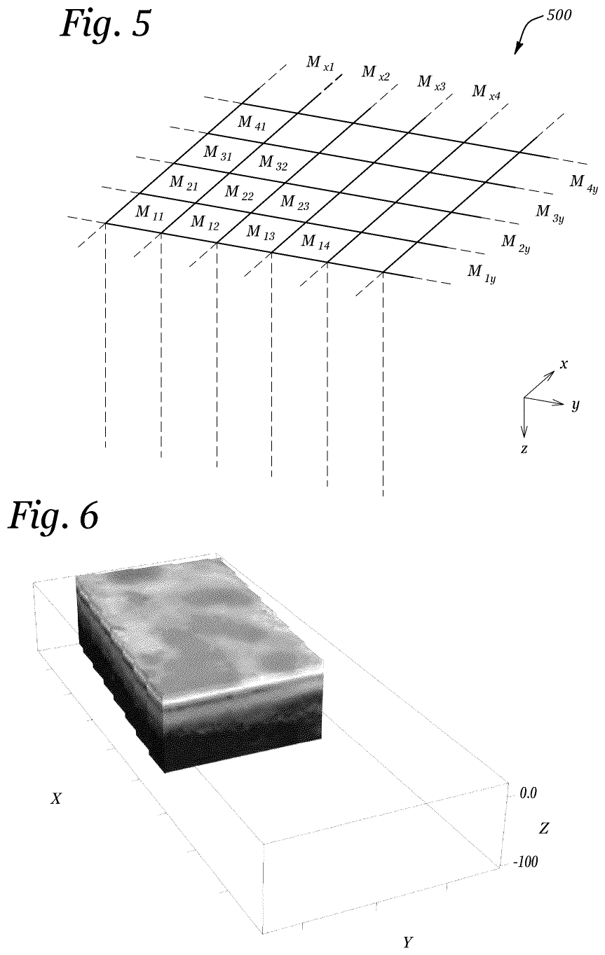

With reference to FIG. 5, an example shear wave velocity model 500 has a grid of cells mxy across the surface above the subsurface target volume, comprising columns mx1, mx2, mx3, etc. extending in the x-direction and rows m1y, m2y, m3y, etc extending in the y-direction. Each cell defines an area of the surface. For example, each cell may define a 5 m by 5 m square; other example options include a 1 m by 1 m square, or a 10 m by 10 m square. In other words, the shear wave velocity model comprises a plurality of cells arranged in a two-dimensional grid 500. The two-dimensional grid spans at least the area of the surface above the subsurface target region. Choosing a smaller cell area increases the resolution of the model. Each cell also includes a volume extending vertically below the area of the surface.

In some examples, the shear wave velocity model 500 is not a grid of square cells but instead comprises cells having a rectangular shape, a rhombic shape or otherwise tessellating shapes including non-uniform shapes or a combination of different shapes.

Each cell is associated with a shear wave velocity value, an example of a ground property value, which represents the expected value of shear wave velocity in the actual subsurface target region of interest. The shear wave value carries depth information, either in that the shear wave value is constant throughout the target region below the cell area or in how the shear wave value varies with depth. For example, the defined shear wave value for each cell may be explicitly a function of depth, either a continuous function or a series of values with associated ranges of depth for each value. In another example, the shear wave value may be a function of frequency, which corresponds to depth information because surface wave propagation is influenced by the physical properties of the subsurface volume up to approximately one wavelength depth. In other words, surface waves at low frequencies are affected by physical properties at deeper depths than surface waves at high frequencies.

Meanwhile, a ray path is defined as a line between the first and second receivers. The ray path signifies the motion of a surface wave as it travels from the first receiver to the second receiver (or vice versa) according to ray theory. In particular, a ray path is defined as the direction of propagation of a surface wave, i.e. the direction perpendicular to wave fronts in wave theory or perpendicular to travel-time contours. In more general terms, a ray path is the line between receivers in a receiver pair.

Also important to both the one-step approach and the two-step approach is the initial model of step 410 of the method 400. The initial model sets initial physical property values for each cell of the initial model, which the method 400 will refine using the response signals. Accordingly, it is not essential for the initial model and initial physical property values to be a highly accurate or high-resolution model of the subsurface target region, although a more accurate initial model may increase the expected accuracy of the end result of the method or decrease the computational time to reach the end result.

In some examples, the initial model is determined based on a user input (for example, according to historic data or map information indicating possible ground property values across the subsurface target region). Alternatively, the initial model may be determined using the first and second response signals (and other response signals, if there are more than two response signals). This is done by performing an inversion of group velocity or phase velocity dispersion curves between the first and second response signals (and others, if present), which can be calculated from cross-correlation of the response signals as described above, to find a using a coarser grid or quicker method. As a last resort, an arbitrarily chosen typical value of the ground property can be used for each cell as a starting point. In these examples, the arbitrary model may be selected based on an estimation of the ground properties of the subsurface target region.

The two-step approach will now be described. This is described in the context of there being a plurality of receivers. In other examples, there may be only the first and second receivers.

In this example, the two-step approach comprises selecting a subset of the plurality of virtual-source receiver pairs, wherein the surface wave ray path between each virtual-source receiver pair (that is the ray path between the virtual source and the receiver in each pair) traverses two or more cells. Usefully, this selection process reduces the amount of computation required in generating the model of the target region, and so speeds up the method.

Next, the approach comprises performing tomographic inversion using the cross-correlated response signals for each virtual-source receiver pair in the subset. In this way, the ground property value can be obtained for each cell.

The tomographic inversion for the two-step approach involves a method for carrying out traveltime tomography on the group traveltime information obtained for each of the selected source-receiver pairs. This process tomographically maps the group traveltime information from each source-receiver pair into the cells of the physical property model. The result of the process is therefore an empirical model of group or phase velocity (depending on the traveltime data used), with each cell of the model having a respective group or phase velocity value. This process is carried out for each of a plurality of frequencies to obtain group or phase velocity values for each cell for each frequency. This process is the first stage (i.e. the tomography stage) of the two-step approach to tomographic inversion.

In more detail, the first stage involves first obtaining the initial group velocity model. This can be done in substantially the same way as already mentioned.

Next, the first stage involves determining modelled travel times for each of the selected source-receiver pairs using the initial group velocity model. This is carried out by identifying the wave path from the source to the receiver (for example as a straight ray, curved ray or Fresnel zone) and identifying the cells that are traversed by the wave path. The modelled traveltime based on the initial velocity model is then determined based on the known distance between the source and receiver and the velocity values of each cell traversed by the wave path.

Next, the first stage involves determining an error value indicative of the difference between the modelled travel times and the empirical travel times for each of the selected source-receiver pairs.

Next, the first stage involves determining an updated initial group velocity model using the error value. The updated model is generally in all aspects the same as the initial group velocity model except for new group velocity values associated with at least some of the cells. In other words, the updated model is an updated version of the initial group velocity model taking into account the determined error value between the empirical and modelled group traveltimes for each source-receiver pair. This feedback process may involve a least-squares method, Markov-chain Monte Carlo method or other inversion technique to iteratively update the initial model based on an updated model.

The steps described are typically all part of a subroutine of the first stage tomographic process, which is then iterated according to the inversion method such as least-squares inversion. The iteration continues until the error value reaches an end condition, for example, the error value falling below a threshold.

Once the tomography of the first stage process has been carried out, the two-step tomographic inversion approach can proceed to the second stage: the inversion. This second stage is to obtain the resultant model of the ground property of the target region. As with the first stage tomographic process, the second stage inversion process is carried out for each of a plurality of frequencies to obtain group or phase velocity values for each cell for each frequency

The second stage comprises a first step of obtaining an initial model of the ground property of the subsurface region. This can be done in substantially the same way as already mentioned. The initial model sets initial physical property values for each cell of the model, which the method will refine using the group velocity model obtained from the first stage (iterative) tomographic process using a further iterative process.

Next, the second stage comprises determining modelled surface wave velocities for each cell based on the initial model. To do this, a forward modelling approach is used.

Next, the second stage comprises determining an error value indicative of the difference between the modelled velocities (determined based on the initial model) and the empirical velocities (obtained from the first stage tomography process) for each cell of the model. The error value may be determined for each cell in a similar manner to that described in relation to the first stage in which an error value is determined between modelled and empirical traveltimes for each source-receiver pair. In some examples, the initial model may be determined based on empirical phase dispersion data between source-receiver pairs.

Next, the second stage comprises determining an updated physical model based on the error value determined. The updated physical model is generally in all aspects the same as the initial physical model except for new physical property values associated with at least some of the cells. In other words, the updated model is an updated version of the initial physical model taking into account the determined error value between the empirical and modelled surface wave velocities for each cell of the model. This feedback process may involve a least-squares method, Markov-chain Monte Carlo method or other inversion technique to iteratively update the initial physical model based on an updated physical model.

The steps described are typically all part of a subroutine of the second stage tomographic process, which is then iterated according to the inversion method such as least-squares inversion. The iteration continues until the error value reaches an end condition, for example, the error value falling below a threshold.

Ultimately, the final model is the 2D or 3D model of the target region in terms of the one or more ground properties generated (and, optionally output to a user device, say), at step 460.

The one-step approach will now be described in more detail. As for the two-step approach, this is described in the context of there being a plurality of receivers. In other examples, there may be only the first and second receivers.

In short, two key differences between the one-step approach and the two-step approach are that: (1) whereas in the two-step approach, the analysis is carried out cell-by-cell, in the one-step approach, the analysis is based on each selected ray path; and (2) whereas in the two-step approach, the tomography and inversion are combined in that they relate to the same step of the method but they are performed in turn as two separate steps, in the one-step approach, tomography and inversion and combined into a single step.

The method of the one-step approach comprises selecting a plurality of ray paths out of the total number of possible ray paths between pairs of receivers. To reduce the processing burden, it is usually beneficial to select a subset of ray paths between receivers. The end result of this selecting step is a selection of ray paths for which dispersion functions (e.g. a group velocity dispersion function and/or a phase velocity dispersion function) can be determined using the response signals from the receivers at each end of the respective ray path.

Next, the method of the one-step approach comprises determining an empirical dispersion function for each ray path, in particular, each ray path selected in the selecting part of the method. The dispersion function may be a group velocity dispersion function or a phase velocity dispersion function (or both may be used). The group velocity dispersion function may be determined as described above with reference to FIG. 1, according to any of the usual methods in the art.

Next, the method comprises determining a modelled dispersion function for each ray path using the initial model.

The steps of determining the empirical dispersion function and the modelled dispersion function may be performed in any order (or indeed concurrently).

Next, the method comprises determining an error value indicative of the difference between the modelled dispersion function (determined from the model) and the empirical dispersion function (determined from the detected response signals) for each ray path.

Finally, the method comprises updating the initial model using the error value. The updated model is generally in all aspects the same as the initial model except for new shear wave velocity values (or whichever physical property values are used) are associated with at least some of the cells. In other words, the second model is an updated version of the first model taking into account the determined error value between the empirical and modelled dispersion functions. This feedback process is typically built into the inversion method, e.g. a least-squares method, Markov-chain Monte Carlo method etc. and performed as part of the inversion routine.

The parts of the method of determining the modelled dispersion function, determining the error value, and determining the updated model using the error value are typically all part of a subroutine of the one-step approach, which is then iterated according to the inversion method such as least-squares gradient-descent inversion. In other words, each time an updated model is determined using the error value resulting from the initial model and resulting modelled dispersion functions for each ray path, the resulting updated model is then used as the initial model for the next iteration. The iteration continues until the error value reaches an end condition, for example, the error value falling below a threshold.

Ultimately, the final updated model is the 2D or 3D model of the target region in terms of the one or more ground properties generated (and, optionally output to a user device, say), at step 460.

An advantage of the one-step approach is that by focusing on ray paths and doing a one-step tomography and inversion based on the ray paths (not every cell, say), the computational burden is reduced, thus reducing the time taken.

For completeness, the tomographic inversion operation used in method 400 may be similar—but different—to that used in multi-channel analysis of surface waves (MASW). MASW has already been described and is an existing technique for gathering surface wave information. Key differences between the described approaches towards tomographic inversion and MASW include that MASW does not use tomographic inversion (instead, a one-dimensional (1D) inversion is used); MASW works with active noise sources (such as sledgehammers or weight drops,), and MASW works with 2D lines of interest along the surface. The target depth in MASW is around 5 to 30 m, and so MASW cannot penetrate as deeply as the approach of the present disclosure.

With reference to FIG. 6, an example output of the methods described herein is a final shear wave velocity model showing a subsurface target region. The subsurface target region extends in x and y directions to a depth (z direction) of 100 m. The values of shear wave velocity are shown by the shading in the plot and the transition between regions of different shear wave velocity are visible, which indicates the different composition or structure of portions of the subsurface target region. Using the methods described herein, a final shear wave velocity model can be determined with higher resolution and accuracy without resulting in an unfeasible compute time. Such a subsurface model can be used to better understand the suitability of the subsurface target volume for supporting man-made structures on top of or in the subsurface target region.

As already mentioned, there may be more than two receivers. For example, there may be 100 receivers, between 100 and 5000 receivers, 5000 receivers, or more than 5000 receivers.

There are many different types of receiver suitable for use in the method 300. For example, the receivers in the method 300 may be any of (or any combination of): geophones, accelerometers, seismometers, vibration sensors and transducers.

The target region may be of varying depths and positions relative to the surface. For example, in terms of depth below the surface, the method 300 may be suitable for determining one or more ground properties of a target region at a depth of up to around 100 m. For example, the target region may span 0 to 100 m below the surface; it may span 0 to 45 m below the surface; it may span 50 to 100 m below the surface. Thus the target region may be entirely contained within the subsurface. This makes the described method well suited to a variety of different construction projects, including underground projects.

In some implementations, the processing of the response signals at step 320 includes applying spectral whitening. This technique helps to accentuate the representation of the frequencies of interest of the ambient noise and, as a result, avoids signals in the micro seismic band from dominating the cross-correlation performed at step 330.

The model and the one or more ground properties may be a ground property other than shear wave velocity, or additional to shear wave velocity, such as compressional wave velocity, density, elastic modulus, shear modulus, or, if a viscoelastic model is being used, optionally also viscosity quality factors Qs and Qp. In general, the model may define multiple ground property values.

FIG. 7 shows a block diagram of one implementation of a computing device 700 within which a set of instructions, for causing the computing device to perform any one or more of the methodologies discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 700 includes a processor 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a secondary memory (e.g., a data storage device 718), which communicate with each other via a bus 730.

Processor 702 represents one or more general-purpose processors such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processors such as an application specific integrated circuit (ASIC), a field programmable gate array (FPGA), a digital signal processor (DSP), network processor, or the like. Processor 702 is configured to execute the processing logic (instructions 722) for performing the operations and steps discussed herein.

The computing device 700 may further include a network interface device 708. The computing device 700 also may include a video display unit 710 (e.g., a liquid crystal display (LCD) or a cathode ray tube (CRT)), an alphanumeric input device 712 (e.g., a keyboard or touchscreen), a cursor control device 714 (e.g., a mouse or touchscreen), and an audio device 716 (e.g., a speaker).

It will be apparent that some features of computer device 700 shown in FIG. 7 may be absent. For example, one or more computing devices 700 may have no need for display device 710 (or any associated adapters). This may be the case, for example, for particular server-side computer apparatuses 700 which are used only for their processing capabilities and do not need to display information to users. Similarly, user input device 712 may not be required. In its simplest form, computer device 700 comprises processor 702 and memory 704.

The data storage device 718 may include one or more machine-readable storage media (or more specifically one or more non-transitory computer-readable storage media) 728 on which is stored one or more sets of instructions 722 embodying any one or more of the methodologies or functions described herein. The instructions 722 may also reside, completely or at least partially, within the main memory 704 and/or within the processor 702 during execution thereof by the computer system 700, the main memory 704 and the processor 702 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid state memory, magnetic tape, a removable computer diskette, a random access memory (RAM), a read-only memory (ROM), a rigid magnetic disc, and an optical disk, such as a CD-ROM, CD-RW or DVD.

In an implementation, the modules, components and other features described herein can be implemented as discrete components or integrated in the functionality of hardware components such as ASICS, FPGAS, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “providing, “calculating”, “updating”, “generating”, “receiving”, “processing”, “performing”, “determining”, “selecting”, “comparing, and “identifying”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described, but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method for determining one or more ground properties of a target region beneath a surface of earth, the method comprising:
receiving a data set, the data set comprising:
a first response signal, the first response signal indicative of ambient noise measured at or near the surface by a first receiver arranged at a first location; and
a second response signal, the second response signal indicative of the ambient noise measured at or near the surface by a second receiver arranged at a second location, wherein the first location and the second locations are different;
processing the first response signal and the second response signal;
cross-correlating the processed first response signal with the processed second response signal; and
performing tomographic inversion using the cross-correlated response signals to generate a two-dimensional (2D) or three-dimensional (3D) model of the target region in terms of the one or more ground properties.

2. The method of claim 1, wherein the target region is up to 100 m below the surface.

3. The method of claim 1, wherein ground risk management framework decisions are taken based on the 2D or 3D model.

4. The method of claim 1, wherein each of the first response signal and the second response signals is indicative of a vertical component and/or horizontal component of the ambient noise measured at or near the surface by the first receiver and the second receiver, respectively.

5. The method of claim 1, wherein before receiving the data set, determining the first location and the second locations for the first receiver and the second receivers is based on minimum and/or maximum depth of the target region and/or desired resolution of waves in the target region caused by the ambient noise.

6. The method of claim 1, wherein before receiving the data set, selecting a recording frequency for the first receiver and the second receiver, wherein the recording frequency selected is based on a depth of the target region and/or an expected wavelength of noise waves in the target region.

7. The method of claim 1, wherein the one or more ground properties comprises one or more elastic properties of the target region, such as shear-velocity.

8. The method of claim 1, further comprising:
processing the first response signal and the second response signals to accentuate a representation of the ambient noise.

9. The method of claim 1, further comprising:
splitting each response signal into segments;
trimming each segmented response signal to a nearest second;
applying a low-pass filter to each response signal; and/or
downsampling each response signal.

10. The method of claim 1, wherein cross-correlating further comprising:
estimating Green's function between the first receiver and the second receiver.

11. The method of claim 1, further comprising:
providing an initial model of the one or more ground properties of the target region;
providing a noise input for the initial model;
calculating, using the initial model, travel time of one of the first response signal or second response signal that would be measured at the first and second receivers;
comparing the travel time calculated using the initial model to the cross-correlated first and second response signals; and
based on the comparison, updating the initial model to generate the 2D or 3D model.

12. The method of claim 11, further comprising:
determining a phase velocity dispersion profile between a virtual source and a selected one of the first receiver and the second receivers.

13. (canceled)

14. A system comprising:
one or more processors;
one or more memories storing instructions, which when executed by the one or more processors, cause the system to:
receive a data set, the data set comprising:
a first response signal, the first response signal indicative of ambient noise measured at or near a surface by a first receiver arranged at a first location; and
a second response signal, the second response signal indicative of the ambient noise measured at or near the surface by a second receiver arranged at a second location, wherein the first location and the second location are different;
process the first response signal and the second response signal;
cross-correlate the processed first response signal with the processed second response signal; and
perform tomographic inversion using the cross-correlated response signals to generate a two-dimensional (2D) or three-dimensional (3D) model of a target region in terms of one or more ground properties.

15. (canceled)

16. The system of claim 14, wherein the target region is up to 100 m below the surface.

17. The system of claim 14, wherein ground risk management framework decisions are taken based on the 2D or 3D model.

18. The system of claim 14, wherein each of the first response signal and the second response signal is indicative of a vertical component and/or horizontal component of the ambient noise measured at or near the surface by the first receiver and the second receiver, respectively.

19. The system of claim 14, wherein before receiving the data set, the system is configured to:
determine the first location and the second location for the first receiver and the second receiver is based on minimum and/or maximum depth of the target region and/or desired resolution of waves in the target region caused by the ambient noise.

20. The system of claim 14, wherein before receiving the data set, the system is configured to:
select a recording frequency for the first receiver and the second receiver, wherein the recording frequency selected is based on a depth of the target region and/or an expected wavelength of noise waves in the target region.

21. The system of claim 14, wherein the one or more ground properties comprises one or more elastic properties of the target region, such as shear-velocity.

22. The system of claim 14, further comprising instructions, which when executed by the one or more processors, cause the system to:
process the first response signal and the second response signal to accentuate a representation of the ambient noise.
